(19) United States
(12) Patent Application Publication
(10) Pub. No.: US 2009/0038451 A1
(43) Pub. Date: Feb. 12, 2009

(54) METHOD FOR MONITORING CUTTING BLADE FUNCTIONALITY

(75) Inventor: Nir BARKAI, KFAR SABA (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(73) Assignee: SOLIDIMENSION LTD, BE'EROT ITZHAK (IL)

(21) Appl. No.: 11/836,154

(22) Filed: Aug. 9, 2007

(51) Int. Cl. B26D 5/00

(52) U.S. Cl. 83/13

(57) ABSTRACT

The present invention provides a method for monitoring the functionality of the contour cutting blade by cutting at least a portion of the top sheet, which is connected to the reservoir of sheet material, along a separation line with the cutting blade so as to at least partially separate the stack portion of sheet material from the reservoir of sheet material. The separation line, therefore, defines the trailing edge of the stack portion of the sheet and a leading edge of the reservoir of sheet material. Checking the functionality of the cutting blade is achieved by retracting the leading edge of the reservoir from the trailing edge of the stack portion. The ability to perform this retracting step is considered as indication that the cutting blade is functioning properly. Likewise, the inability to perform this retracting step is considered as indication that the cutting blade has malfunctioned and an appropriate resolution is required.

### FIELD AND BACKGROUND OF THE INVENTION

The present invention relates to systems for constructing a three-dimensional object by selective attachment of a plurality of sheets of flexible material and, in particular, it concerns a method for monitoring the functionality of a contour cutting blade used in the system.

It is known to build up three-dimensional structures by attaching together layers of sheet material each cut to the contour of a thin slice of the object. This technique can be used in a wide range of applications, and has particular advantages for rapid construction of small numbers of individual prototypes and models using CAD (computer-aided-design) techniques, or to facilitate the manufacture of three-dimensional objects using CAM techniques. An example of this technique is described in PCT Patent Publication No. WO99/34976, which is incorporated herein in full.

This process includes cutting the contour of the object through only one sheet of material. The cutting may be made more difficult depending on the intricacy of the contour. Therefore, a relatively delicate contour cutting blade is used. However, the prior art does not seem to address the problem of monitoring the functionality of the contour cutting blade. Malfunction of the contour cutting bladed during the object building process may result in the inability to remove the object from the surrounding block upon completion of the building process.

There is therefore a need for a method for monitoring the functionality of the contour cutting blade in a system for constructing a three-dimensional object by selective attachment of a plurality of sheets of flexible material.

### SUMMARY OF THE INVENTION

The present invention is a method for monitoring the functionality of the contour cutting blade in a system for constructing a three-dimensional object by selective attachment of a plurality of sheets of flexible material.

According to the teachings of the present invention there is provided, a method for monitoring the functionality of a contour cutting blade for use in a system for constructing a three-dimensional object by selective attachment of a plurality of sheets of flexible material so as to form a stack of sheets, each sheet being cut along at least one contour line so as to subdivide the sheet into at least one object forming region and at least one residue region, and after cutting a required contour cut, in a top sheet of the stack, along at least one contour line using the contour cutting blade, the method comprising: a) cutting the top sheet along a separation line with the contour cutting blade so as to separate a stack portion of the top sheet from a non-stack portion of the top sheet; and b) checking functionality of the contour cutting blade by separating the stack portion of the top sheet from the non-stack portion of the top sheet; wherein the functionality of the contour cutting blade is determined by an ability to perform the separating.

According to a further teaching of the present invention, there is also provided including the steps of: a) drawing the top sheet from a reservoir of sheet material; b) deploying the top sheet on the top of the stack of sheets; c) after cutting the required contour cut; d) cutting at least a portion of the separation line with the cutting blade so as to at least partially separate the top sheet from the reservoir of sheet material, the separation line defining a trailing edge of the top sheet and a leading edge of the reservoir of sheet material; e) trimming a remaining portion of the sheet separation line so as to fully separate the top sheet material from the reservoir of sheet material; and f) checking functionality of the cutting blade by retracting the leading edge of the reservoir from the trailing edge of the top sheet so as to separate the leading edge of the reservoir from the trailing edge of the top sheet.

According to a further teaching of the present invention, the reservoir of sheet material is implemented as a roll of flexible sheet material.

According to a further teaching of the present invention, the separation line is implemented as a linear separation line.

According to a further teaching of the present invention, the separation line is implemented as a non-linear separation line.

According to a further teaching of the present invention, a length of the separation line is implemented with an extension portion that extends from one of the leading edge of the reservoir of sheet material and the trailing edge of the stack portion of sheet material.

According to a further teaching of the present invention, the extension portion is implemented with a substantially rectangular contour.

According to a further teaching of the present invention, the extension portion is implemented with a substantially semi-circular contour.

According to a further teaching of the present invention, the extension portion is implemented with a substantially triangular contour.

According to a further teaching of the present invention, the extension portion is implemented with a substantially trapezoidal contour.

According to a further teaching of the present invention, there is also provided a trimming blade configured to perform the trimming.

According to a further teaching of the present invention, the cutting blade and the trimming blade are implemented on a common carrier element.

### BRIEF DESCRIPTION OF THE DRAWINGS

The invention is herein described, by way of example only, with reference to the accompanying drawings, wherein:

FIG. 1 is a schematic isometric view of deployment of a top sheet of a stack of bonded together sheets constructed and operational according to the teachings of the present invention;

FIG. 2 is a schematic isometric view showing the top sheet of FIG. 1 after being cut along a contour line and a separation line;

FIG. 3 is a schematic isometric view of FIG. 2 after separating the stack portion from the non-stack portion of the sheet material;

FIGS. 4-7 are schematic isometric views showing alternative patterns of separation line cuts in which the outline of the separation line is altered; and

FIGS. 8A-8C are schematic isometric views showing alternative patterns of separation line cuts in which the position of the tab formed by the separation line cut is varied.

### DESCRIPTION OF THE PREFERRED EMBODIMENTS

The present invention is a method for monitoring the functionality of the contour cutting blade in a system for constructing a three-dimensional object by selective attachment of a plurality of sheets of flexible material.

The principles and operation of a method for monitoring the functionality for the contour cutting blade according to the present invention may be better understood with reference to the drawings and the accompanying description.

By way of introduction, the present invention is directed toward a method for monitoring the functionality of a contour cutting blade being used in a system for constructing a three-dimensional object by selective attachment of a plurality of sheets of flexible material so as to form a stack of sheets. In constructing the three-dimensional model, each sheet is cut along at least one contour line so as to subdivide the sheet into at least one object forming region and at least one residue region. The method includes drawing a stack portion of sheet material from a reservoir of sheet material. The reservoir is preferably, but not necessarily, a roll of sheet flexible material. The stack portion of sheet material is deployed so as to become a top sheet of the stack of sheets forming the three-dimensional model. Once attached, the required contour in that particular plane of the three-dimensional model is cut along at least one contour line with the cutting blade. Once the three-dimensional model is completed, the stack of now partially bonded together sheets appears substantially as a cube having residue regions surrounding the three-dimensional model. The residue regions are removed so as to free the three-dimensional model. It will therefore be appreciated that any failure of the cutting blade to function properly such as, but not limited to, not fully cutting a required contour and thereby not completely detach the object forming region from the residue region may greatly hinder the ability to remove the residue regions in order to free the three-dimensional model.

The present invention provides a method for monitoring the functionality of the contour cutting blade by cutting at least a portion of the top sheet, which is connected to the reservoir of sheet material, along a separation line with the cutting blade so as to at least partially separate the stack portion of sheet material from the reservoir of sheet material. The separation line, therefore, defines the trailing edge of the stack portion of the sheet and a leading edge of the reservoir of sheet material.

Checking the functionality of the cutting blade is achieved by retracting the leading edge of the reservoir form the trailing edge of the stack portion. The ability to perform this retracting step is considered as indication that the cutting blade is functioning properly. Likewise, the inability to perform this retracting step is considered as indication that the cutting blade has malfunctioned and an appropriate resolution is required.

This resolution may include, but should not be limited to, replacing the cutting blade and re-cutting all cutting operations made on the current top sheet of the stack before resuming normal operation and continue the construction of the three-dimensional model.

Although in its simplest form, the sheet separation line may be fully cut in a single action and the functionality of the contour cutting blade may be determined by the ability to separate the two pieces of the top sheet, the method of the present invention includes a number of alternative cutting actions, as will be discussed herebelow. These alternative cutting actions may include first cutting at least a portion of the sheet separation line and then trimming the remaining portion of the sheet separation line so as to fully separate the stack portion of sheet material from the reservoir of sheet material.

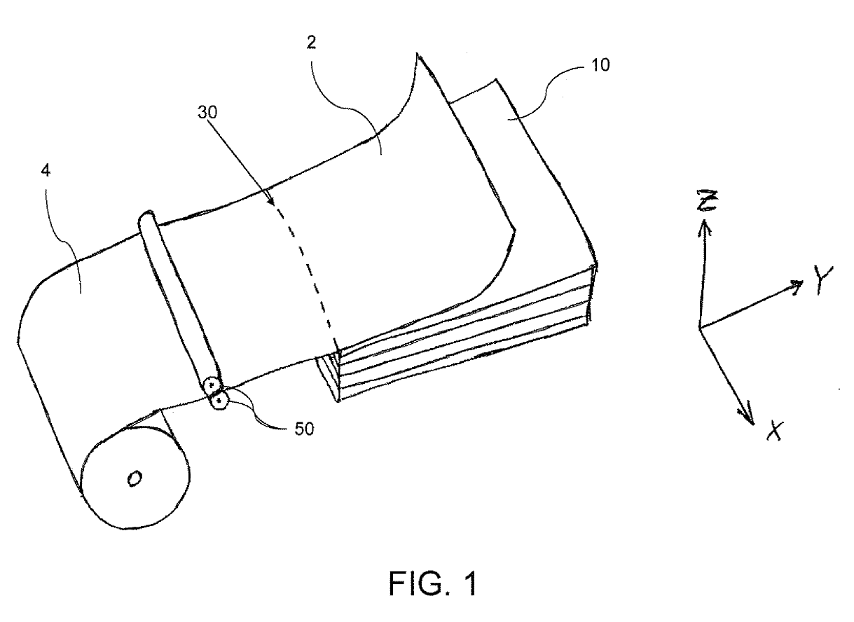

Referring now to the drawings, FIG. 1 schematically illustrates deployment of the top sheet 2 onto the stack 10 of bonded together sheets forming the three-dimensional model. Top sheet 2 is the leading end of the roll of sheet material 4, hereafter referred to as the “reservoir” of sheet material. It should be noted, however, that the principles of the method of the present invention for testing functionality of the contour cutting blade 102 may be applied with equal benefit to a system configured to deploy as the top sheet of the stack individual pre-cut sheets drawn from a reservoir of such sheets.

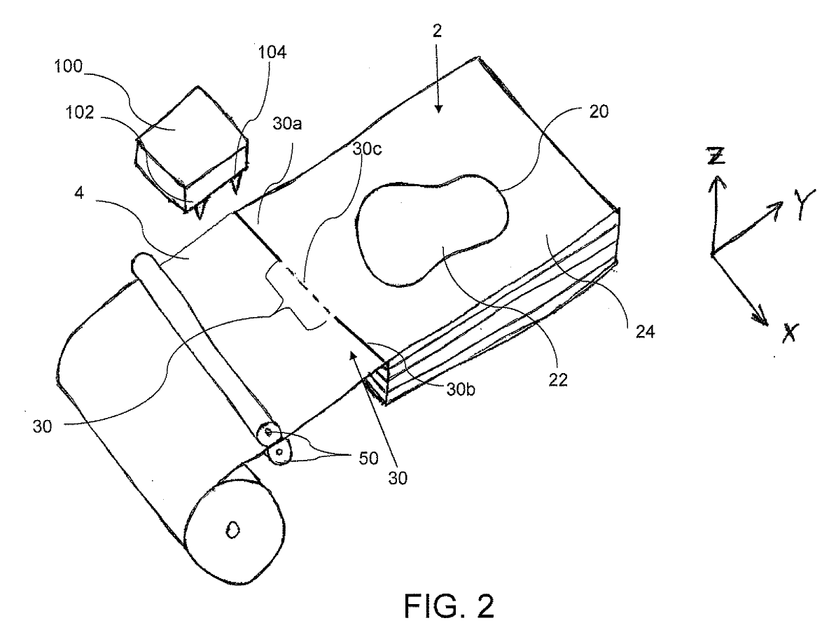

As illustrated in FIG. 2, once deployed, the top sheet 2 is cut along a contour line 20 so as to subdivide top sheet 2 into at least one object, forming region 22 and at least one residue region 24. The sheet material is then cut along a separation line 30 so as to separate the top sheet 2, which is now the stack portion of the sheet material, from the reservoir 4 of sheet material.

In its simplest form, the cut along the separation line 30 may be performed as a single cut. Preferably, however, as illustrated here, separation line 30 is cut initially along segments 30a and 30b using the contour cutting blade 102, and then finally trimmed along segment 30c using a trimming blade 104.

As illustrated in FIG. 2, a preferred embodiment of the present invention further includes a common blade carrier 100 configured to hold both the contour cutting blade 102 and the trimming blade 104.

The cutting of separation line 30 defines the leading edge 40 of the sheet material extending from the reservoir 4, and the trailing edge 26 of top sheet 2 (see FIG. 3).

In order to test the functionality of the contour cutting blade 102 that was used to cut both the contour line 20 and at least a portion of the separation line 30, the sheet material containing the leading edge 40 is displaced so as to separate the leading edge 40 from the trailing edge 26. In the embodiment schematically illustrated here in FIG. 2, this is accomplished by activating the rollers 50 so as to retract the sheet material extending from the reservoir. It will be appreciated that any number of methods and mechanisms known in the art may be used to draw the non-stack forming portion of the sheet material away from the stack forming portion.

The functionality of the contour cutting blade 102 is determined by the ability to retract the sheet material so as to separate the non-stack forming portion of the sheet material from the stack forming portion. That is, to separate the leading edge 40 from the trailing edge 26.

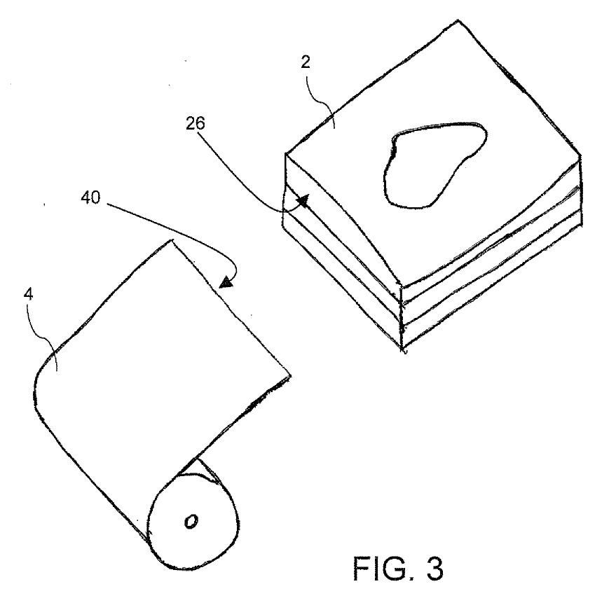

FIG. 4 illustrates a separation line pattern in which segment 30c is trimmed so as to form a substantially triangular shaped notch 50 in trailing edge 26 and a corresponding triangular shaped tab 52 in leading edge 40.

FIG. 5 illustrates a separation line pattern in which segment 30c is trimmed so as to form a substantially trapezoidal shaped notch 56 in trailing edge 26 and a corresponding trapezoidal shaped tab 58 in leading edge 40.

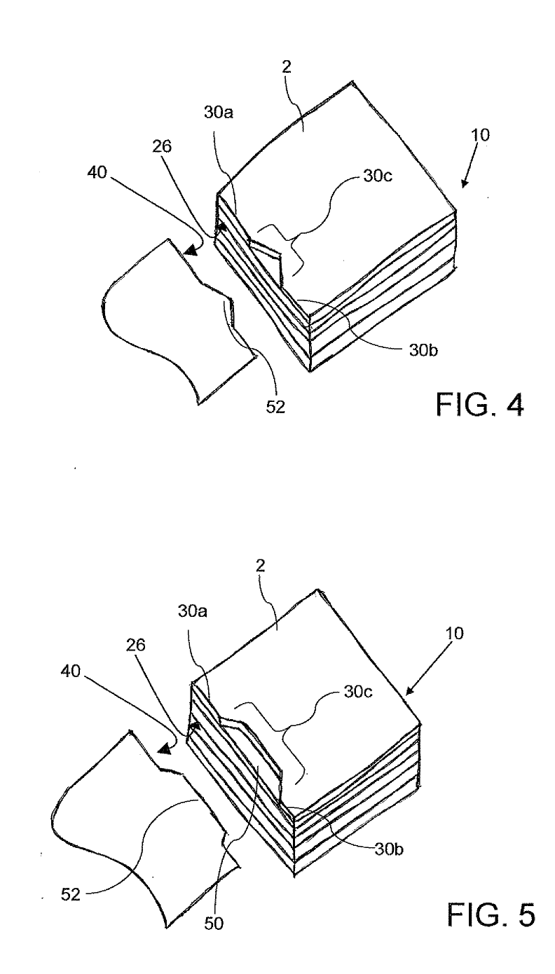

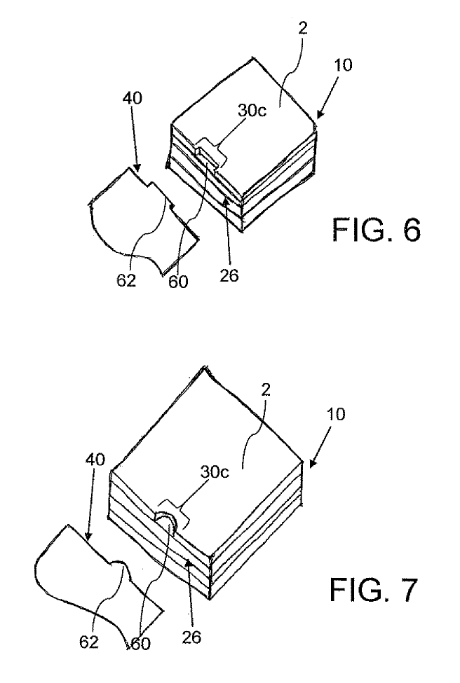

FIG. 6 illustrates a separation line pattern in which segment 30c is trimmed so as to form a substantially rectangular shaped notch 60 in trailing edge 26 and a corresponding rectangular shaped tab 62 in leading edge 40.

FIG. 7 illustrates a separation line pattern in which segment 30c is trimmed so as to form a substantially semi-circular shaped notch 66 in trailing edge 26 and a corresponding semi-circular shaped tab 68 in leading edge 40.

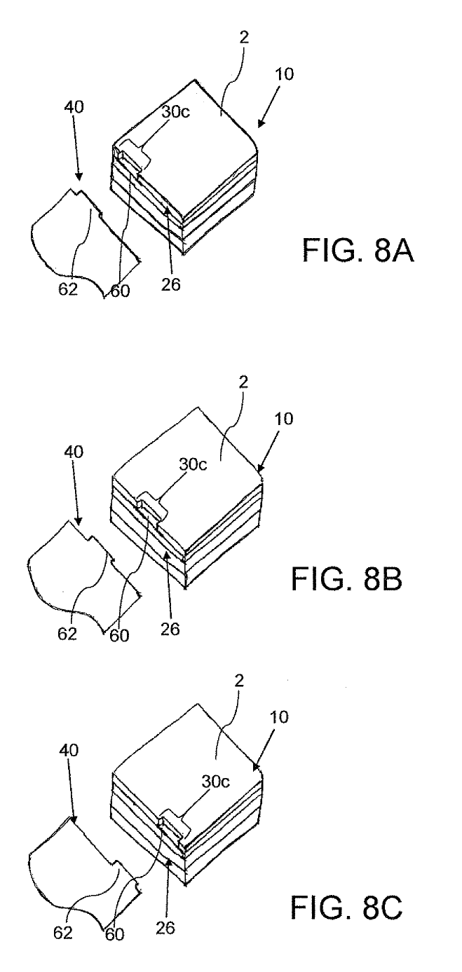

FIGS. 8A-8C illustrate a series of separation line patterns in which the position of segment 30c is varied sequentially across the width W of the stack 10. That is to say, the notch 70 in trailing edge 26 of the top sheet 2 and a corresponding tab 72 in leading edge 40 of the sheet material extending from the reservoir of sheet material are formed at sequentially spaced locations across the width W of stack 10.

It will be appreciated that the above descriptions are intended only to serve as examples and that many other embodiments are possible within the spirit and the scope of the present invention.

What is claimed is:

1. A method for monitoring the functionality of a contour cutting blade for use in a system for constructing a three-dimensional object by selective attachment of a plurality of sheets of flexible material so as to form a stack of sheets, each sheet being cut along at least one contour line so as to subdivide the sheet into at least one object forming region and at least one residue region, and after cutting a required contour cut, in a top sheet of the stack, along at least one contour line using the contour cutting blade, the method comprising:
(a) cutting the top sheet along a separation line with the contour cutting blade so as to separate a stack portion of the top sheet from a non-stack portion of the top sheet; and
(b) checking functionality of the contour cutting blade by separating said stack portion of the top sheet from said non-stack portion of the top sheet;
wherein said functionality of the contour cutting blade is determined by an ability to perform said separating.

2. The method of claim 1, further including the steps of:
(a) drawing the top sheet from a reservoir of sheet material;
(b) deploying the top sheet on the top of the stack of sheets;
after cutting the required contour cut;
(c) cutting at least a portion of said separation line with said cutting blade so as to at least partially separate the top sheet from said reservoir of sheet material, said separation line defining a trailing edge of the top sheet and a leading edge of said reservoir of sheet material;
(d) trimming a remaining portion of said sheet separation line so as to fully separate the top sheet material from said reservoir of sheet material; and
(e) checking functionality of said cutting blade by retracting said leading edge of said reservoir from said trailing edge of the top sheet so as to separate said leading edge of said reservoir from said trailing edge of the top sheet.

3. The method of claim 1, wherein said reservoir of sheet material is implemented as a roll of flexible sheet material.

4. The method of claim 1, wherein said separation line is implemented as a linear separation line.

5. The method of claim 1, wherein said separation line is implemented as a non-linear separation line.

6. The method of claim 5, wherein a length of said separation line is implemented with an extension portion that extends from one of said leading edge of said reservoir of sheet material and said trailing edge of said stack portion of sheet material.

7. The method of claim 6, wherein said extension portion is implemented with a substantially rectangular contour.

8. The method of claim 6, wherein said extension portion is implemented with a substantially semi-circular contour.

9. The method of claim 6, wherein said extension portion is implemented with a substantially triangular contour.

10. The method of claim 6, wherein said extension portion is implemented with a substantially trapezoidal contour.

11. The method of claim 1, further including providing a trimming blade configured to perform said trimming.

12. The method of claim 11, wherein said cutting blade and said trimming blade are implemented on a common carrier element.
